(19) United States
(12) Patent Application Publication
(10) Pub. No.: US 2013/0133762 A1
(43) Pub. Date: May 30, 2013

(54) Wireless Touch-free Faucet Control for Hand Hygiene

(71) Applicant: David Snodgrass, Jupiter, FL (US)

(72) Inventor: David Snodgrass, Jupiter, FL (US)

(73) Assignee: ULTRACLENZ, LLC, Jupiter, FL (US)

(21) Appl. No.: 13/676,231

(22) Filed: Nov. 14, 2012

Related U.S. Application Data
(60) Provisional application No. 61/559,360, filed on Nov. 14, 2011.

(51) Int. Cl. G04F 3/02

(52) U.S. Cl. CPC G04F 3/02
USPC 137/552.7

(57) ABSTRACT

A hand wash control system is provided, comprising a soap dispenser for dispensing soap; a dispenser beacon for detecting when soap has been dispensed by the soap dispenser; a faucet controller connected to a faucet for inhibiting the dispensing of water from a faucet; wherein the faucet controller inhibits the flow of water from the faucet for a certain time after the dispenser beacon detects soap being dispensed by the soap dispenser, to provide an appropriate lather period by a user before rinsing with water.

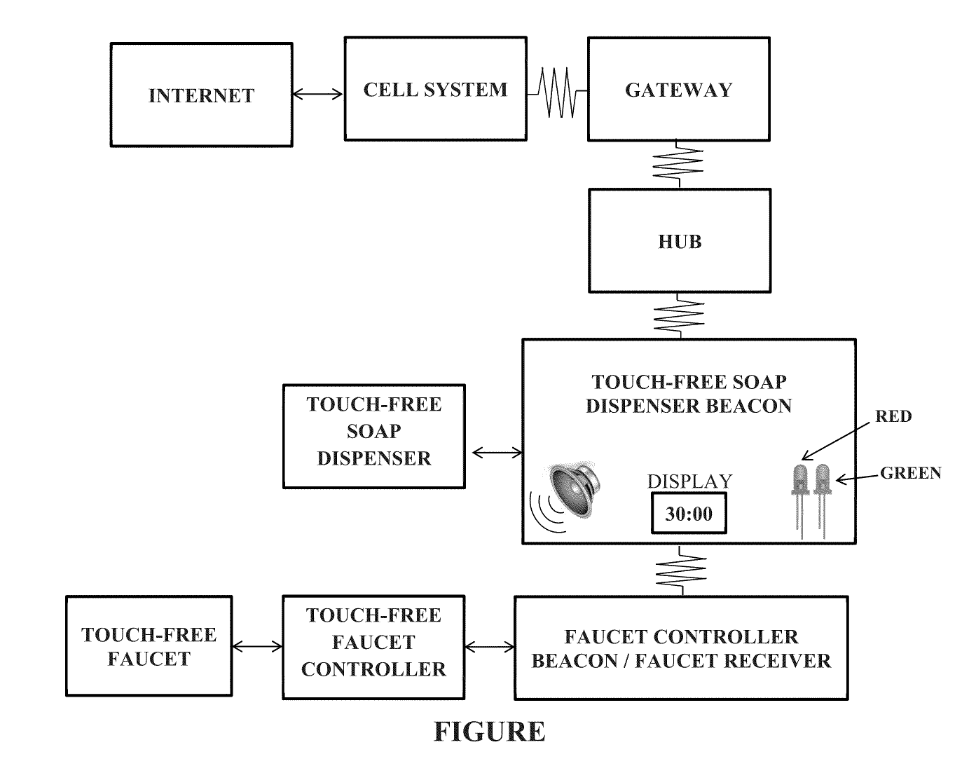

### CROSS-REFERENCE TO RELATED APPLICATION

This application is a non-provisional of provisional application Ser. No. 61/559,360 filed Nov. 14, 2011, which is incorporated by reference herein.

### BACKGROUND OF THE INVENTION

The present invention relates to a hand wash compliance monitoring system for fostering compliant hand wash procedures, particularly lather periods of sufficient duration. The present invention also relates to a communication system which wirelessly transmits hand wash compliance data to an offsite database.

Many employees in the healthcare, food service and like industries, where hand sanitation is needed, do not perform proper hand washes sufficient to cleanse their hands to remove pathogens. To help prevent the spread of pathogens, a user needs to lather their hands for a sufficient period of time, for example at least 20 seconds, in order for the hand wash to be effective.

### SUMMARY OF THE INVENTION

The present invention provides a hand wash compliance system wherein, after soap is dispensed, the system temporarily disables the flow of water from a touch-free faucet for a predetermined period of time to enable and promote a lather period sufficiently long to effectively deal with pathogens.

### DESCRIPTION OF THE DRAWING

The Figure shows an overall configuration of a communication system for hand wash compliance monitoring.

### DESCRIPTION OF A PREFERRED EMBODIMENT

A preferred embodiment will be described, but the present invention is not limited to this embodiment.

The system according to the invention consists of a soap dispenser, dispenser beacon, faucet receiver, touch-free (TF) faucet controller and IF faucet. The dispenser beacon is physically attached to the soap dispenser via a 6 wire flat ribbon cable. The faucet receiver is physically attached to the TF faucet controller via a 4 wire cable and will receive its power from the faucet controller.

When a user activates the dispenser by placing his hands under the dispenser, the dispenser beacon will detect the activation and broadcast a modulated low frequency (LF) inhibit message that is specifically addressed to the faucet receiver. Upon receiving and verifying the inhibit message, the faucet receiver will activate an inhibit signal which instructs the faucet controller disable the flow of water. The water will remain disabled for the duration of the lather delay period which could be programmed to be any value between 5 seconds and 60 seconds, and preferably in the range of 20-30 seconds. The dispenser beacon is equipped with LEDs, red and green, and an acoustic piezo. During the lather delay period count-down, the faucet transmitter's red LED will flash red once per second and the piezo will beep once per second. When the lather delay expires, the faucet transmitter's green LED will flash and the piezo will chime to indicate, to the user, that the lather delay period has expired. At this time, the dispenser beacon will broadcast an uninhibit message specifically addressed to the faucet receiver. Upon receiving and verifying the uninhibit message, the faucet receiver will deactivate the inhibit signal which instructs the faucet controller to enable the flow of water so the user will be able to obtain rinse water by placing their hands beneath the faucet for rinsing.

A completed hand wash will be recorded by the dispenser beacon if all of the following steps have been successfully completed: take soap, lather hands for the lather period and rinse hands. The dispenser beacon can optionally transmit the event data to an offsite database via a wired or wireless network through hub, gateway, cell system and internet.

A display can be designed into the dispenser beacon to show a numeric count-down and status to the user during the lather delay period.

The dispenser beacon may also be programmed to interact with a user's badge and thus become a component of a system disclosed in Ser. No. 13/215,823 filed Aug. 23, 2011, which is incorporated by reference herein. In this case, the badge would only be set to the sanitary (green) state if all of the following steps have been successfully completed: take soap, lather hands and rinse hands. Applicant also incorporates by reference herein U.S. Pat. No. 6,426,701.

What is claimed is:

1. A hand wash control system, comprising:
a soap dispenser for dispensing soap;
a dispenser beacon for detecting when soap has been dispensed by the soap dispenser;
a faucet controller connected to a faucet for inhibiting the dispensing of water from a faucet;
wherein the faucet controller inhibits the flow of water from the faucet for a certain time after the dispenser beacon detects soap being dispensed by the soap dispenser, to provide an appropriate lather period by a user before rinsing with water.

2. The hand wash control system according to claim 1, wherein the faucet controller includes a sensor for detecting the pressure at a user's hands and enables dispensing of water, except during said certain time period when the faucet controller inhibits the flow of water.

3. The hand wash control system according to claim 1, wherein said certain time period is adjustable.

4. The hand wash control system of claim 1, further including an indicator for indicating to a user that the faucet controller is inhibiting the flow of water.

5. The hand wash control system of claim 4, wherein the indicator is a visible colored light.

6. The hand wash control system of claim 1, wherein the indicator is an audible indicator.

7. The hand wash control system of claim 4, wherein the indicator is a countdown timer showing the time remaining in the certain time period.

8. The hand wash control system of claim 1, further including an indicator to inform a user that the certain time has elapsed and that the faucet controller is not inhibiting the flow of water.

9. The hand wash control system of claim 8, wherein the indicator is a visual indicator.

10. The hand wash control system of claim 8, wherein the indicator is an audible indicator.

11. The hand wash control system of claim 1, further including a controller for detecting whether a user has taken soap, and rinsed with water after the certain time period for lathering, to hereby indicate a compliant hand wash.

12. The hand wash control system of claim 1, further including a badge wearable by a user, which identifies the user, and
wherein the dispenser beacon communicates with the badge to determine the identity of the user performing a hand wash.

13. The hand wash control system of claim 11, wherein a compliant hand wash signal is generated and stored in response to a compliant hand wash being detected,

14. The hand wash control system of claim 13, wherein the generated compliant hand wash signal and the identity of the user is stored and date stamped.
